(19) United States
(12) Patent Application Publication
(10) Pub. No.: US 2018/0260183 A1
(43) Pub. Date: Sep. 13, 2018

(54) MEDICAL IMAGE DISPLAY APPARATUS AND DISPLAY CONTROL METHOD

(71) Applicant: Sony Olympus Medical Solutions Inc., Tokyo (JP)

(72) Inventors: Kiyoshi ICHIKAWA, Tokyo (JP); Toshiya SUGAI, Tokyo (JP); Ryu SUKIGARA, Kanagawa (JP); Hideki TASHIRO, Tokyo (JP)

(73) Assignee: Sony Olympus Medical Solutions Inc., Tokyo (JP)

(21) Appl. No.: 15/893,775

(22) Filed: Feb. 12, 2018

(30) Foreign Application Priority Data
Mar. 7, 2017 (JP) 2017-042523

(51) Int. Cl. G06F 3/14; G06F 3/147; G09G 3/36

(52) U.S. Cl. CPC G06F 3/1423; G06F 3/041; G09G 3/36; G06F 3/147

(57) ABSTRACT

There is provided a medical image display apparatus including: a first display unit; and a second display unit that has a different display direction from a display direction of the first display unit. A captured medical image of a space on a back side of the second display unit is displayed on at least a part of a display screen of the second display unit.

### CROSS REFERENCE TO RELATED APPLICATIONS

This application claims the benefit of Japanese Priority Patent Application JP 2017-042523 filed Mar. 7, 2017, the entire contents of which are incorporated herein by reference.

### BACKGROUND

The present disclosure relates to a medical image display apparatus and a display control method.

Technologies related to display apparatuses that can be applied to medical equipment systems have been developed. As the aforementioned technologies, the technology described in JP 2010-131194A described below, for example, is exemplified.

### SUMMARY

In recent years, medical image display apparatuses have been used in medical sites in order to display various images related to medical practices, such as captured medical images captured by an endoscope apparatus and captured medical images captured by electronic imaging-type medical observation apparatuses, for example. In the case of an operating room as an example of a medical site, medical professionals who are involved in a surgery, such as practitioners, perform medical practices while viewing images displayed on a display screen of an image display apparatus as described above. In addition, resolution of captured medical images has increased as functions of the endoscope apparatuses, the electronic imaging-type medical observation apparatuses, and the like have increased. Therefore, increases in sizes of the medical image display apparatuses (increases in sizes of the display screens) have advanced in order to improve precision of medical practices in medical sites.

However, it becomes more difficult for medical professionals who are on a side of a back surface of the medical image display apparatus (on a side of a surface opposite to the surface where the display screen is situated) to view a medical practice that is performed on a side of the display screen of the medical image display apparatus as the size of the medical image display apparatus increases. Therefore, it is considered to become more difficult for the medical professionals who are on the side of the back surface of the medical image display apparatus and the medical professionals who are on side of the display screen of the medical image display apparatus to maintain coordination with each other as the size of the medical image display apparatus used in a medical site increases.

Here, the display apparatus according to the technology described in JP 2010-131194A described above, for example, includes a first display unit that can switch a state to a transmissive state or a non-transmissive state and a second display unit that can switch a state to the transmissive state or the non-transmissive state. In addition, according to the display apparatus according to the technology described in JP 2010-131194A described above, captured images captured by an imaging device that captures the inside of a body are displayed on the first display unit and the second display unit, respectively. Accordingly, each of a person who views a display screen of the first display unit of the display apparatus and a person who views a display screen of the second display unit of the display apparatus can view behind the display screens by using the display apparatus according to the technology described in JP 2010-131194A described above, for example.

However, the transmissive state is not realized if corresponding regions in the display screen of the first display unit and the display screen of the second display unit are not in the transmissive state in a case in which the display apparatus according to the technology described in JP 2010-131194A described above is used, for example. In addition, the respective regions that can display the images in the display screen of the first display unit and the display screen of the second display unit are respectively limited in a case in which the transmissive state is realized in the display apparatus according to the technology described in JP 2010-131194A described above.

The present disclosure proposes a novel and improved medical image display apparatus and a control method capable of improving convenience.

According to an embodiment of the present disclosure, there is provided a medical image display apparatus including: a first display unit; and a second display unit that has a different display direction from a display direction of the first display unit. A captured medical image of a space on a back side of the second display unit is displayed on at least a part of a display screen of the second display unit.

In addition, according to an embodiment of the present disclosure, there is provided a display control method that is performed in a medical image display apparatus including a first display unit and a second display unit that has a different display direction from a display direction of the first display unit, the method being executed by a processor, the method including: controlling display such that a captured medical image of a space on a back side of the second display unit is displayed on at least a part of a display screen of the second display unit.

According to an embodiment of the present disclosure, it is possible to improve convenience.

Note that the effects described above are not necessarily limitative. With or in the place of the above effects, there may be achieved any one of the effects described in this specification or other effects that may be grasped from this specification.

### BRIEF DESCRIPTION OF THE DRAWINGS

FIG. 1 is an explanatory diagram illustrating an example of arrangement of medical image display apparatus in a medical site;

FIG. 2 is an explanatory diagram illustrating an example of an appearance of the medical image display apparatus according to an embodiment;

FIG. 3 is an explanatory diagram illustrating an example of a configuration of the medical image display apparatus according to the embodiment;

FIG. 4 is an explanatory diagram schematically illustrating configurations of a first display panel included in a first display unit and a second display panel included in a second display unit provided in the medical image display apparatus according to the embodiment;

FIG. 5 is an explanatory diagram illustrating a first display example of the medical image display apparatus according to the embodiment;

FIG. 6 is an explanatory diagram illustrating a second display example of the medical image display apparatus according to the embodiment;

FIG. 7 is an explanatory diagram illustrating a third display example of the medical image display apparatus according to the embodiment;

FIG. 8 is an explanatory diagram illustrating a fourth display example of the medical image display apparatus according to the embodiment;

FIG. 9A is an explanatory diagram illustrating a fifth display example of the medical image display apparatus according to the embodiment;

FIG. 9B is an explanatory diagram illustrating the fifth display example of the medical image display apparatus according to the embodiment;

FIG. 10A is an explanatory diagram illustrating a sixth display example of the medical image display apparatus according to the embodiment; and

FIG. 10B is an explanatory diagram illustrating the sixth display example of the medical image display apparatus according to the embodiment.

### DETAILED DESCRIPTION OF THE EMBODIMENT(S)

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

In addition, description will be given below in the following order.
1. Medical image display apparatus according to embodiment and display control method according to embodiment
2. Program according to embodiment

### (Medical Image Display Apparatus According to Embodiment and Display Control Method According to Embodiment)

Hereinafter, an example of a medical image display apparatus according to an embodiment, and display that is realized by a display control method according to the embodiment will be described.

Also, a case in which the medical image display apparatus according to the embodiment is used in an operating room (an example of a medical site) will be exemplified below. In addition, a use case of the medical image display apparatus according to the embodiment is not limited to the use case in which the apparatus is used in a medical site such as an operating room, and the medical image display apparatus according to the embodiment can be applied to an arbitrary use case in which the medical image display apparatus is used.

In addition, a case in which the medical image display apparatus according to the embodiment is an active-matrix-type medical image display apparatus will be mainly described below. Also, it is needless to say that the medical image display apparatus according to the embodiment is not limited to the active-matrix-type medical image display apparatus.

### [1] Outline of Medical Image Display Apparatus According to Embodiment

First, an outline of the medical image display apparatus according to the embodiment will be described.

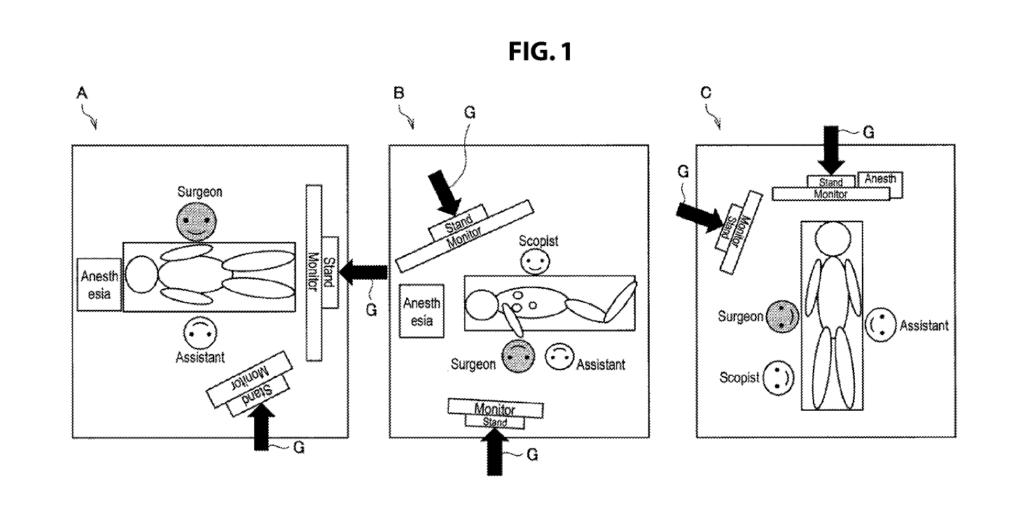

FIG. 1 is an explanatory diagram illustrating examples of arrangement of the medical image display apparatus in medical sites. A illustrated in FIG. 1, B illustrated in FIG. 1, and C illustrated in FIG. 1 illustrate examples of arrangement of the medical image display apparatus in medical sites, respectively. In FIG. 1, the medical image display apparatus is represented as “monitor.”

As illustrated by the reference numeral G in each of A of FIG. 1 to C of FIG. 1, for example, a line of sight of a medical professional who is on a side of a back surface of the medical image display apparatus (on a side of a surface opposite to a surface where a display screen is situated) is obstructed by the medical image display apparatus. Therefore, it becomes more difficult for the medical professional who is on the side of the back surface of the medical image display apparatus (the side of the surface opposite to the surface where the display screen is situated) to view a medical practice that is performed on a side of the display screen of the medical image display apparatus as the size of the medical image display apparatus increases.

Therefore, it is considered to become more difficult for the medical professional who is on the side of the back surface of the medical image display apparatus and a medical professional who is on the side of the display screen of the medical image display apparatus to maintain coordination with each other as the size of the medical image display apparatus used in the medical site increases as described above.

Thus, the medical image display apparatus according to the embodiment includes a first display unit and a second display unit that has a different display direction from a display direction of the first display unit. Display on the respective display screens of the first display unit and the second display unit is controlled by a control unit (which will be described later) provided in the medical image display apparatus according to the embodiment or an external control device (which is not illustrated in the drawing) of the medical image display apparatus according to the embodiment, for example.

Here, a back side of the second display unit according to the embodiment is a back side with respect to the display surface of the second display unit. In addition, a vertical direction of a plane corresponding to the display screen of the first display unit is exemplified, for example, as the display direction of the first display unit according to the embodiment. In addition, a vertical direction of a plane corresponding to the display screen of the second display unit is exemplified, for example, as the display direction of the second display unit according to the embodiment. Also, the display direction of the first display unit and the display direction of the second display unit according to the embodiment are not limited to the examples described above and may be directions that are set on a similar basis with respect to the respective display units.

For example, the first display unit and the second display unit are provided such that the display direction of the first display unit and the display direction of the second display unit are opposite directions (that is, such directions that the angle between the display directions of the respective display units is 180 [°]) in the medical image display apparatus according to the embodiment. In addition, the display direction of the first display unit and the display direction of the second display unit are not limited to the opposite directions. For example, the first display unit and the second display unit may be provided such that the angle between the display directions of the respective display units is X [°] (X is an arbitrary value that is greater than 0 and less than 180) in the medical image display apparatus according to the embodiment. For example, the angle between the display direction of the first display unit and the display direction of the second display unit is set in a design stage or the like in consideration of a purpose of the medical image display apparatus according to the embodiment, cost of the medical image display apparatus according to the embodiment, and the like.

In addition, a captured medical image (a stationary image or a moving image) of a space on the back side of the second display unit or the side of the display direction of the first display unit is displayed on at least a part of the display screen of the second display unit in the medical image display apparatus according to the embodiment. Displaying the captured medical image on the entire display screen of the second display unit and displaying the captured medical image in a region that is a part of the display screen of the second display unit are included in displaying the captured medical image on at least a part of the display screen of the second display unit.

If the case in which the medical image display apparatus according to the embodiment is used in a medical site such as an operating room is exemplified, an image of a space at a location where a medical practice is performed, for example, is exemplified as the captured medical image of the space on the back side of the second display unit or the side of the display direction of the first display unit according to the embodiment.

Here, an image captured by an imaging device provided in the medical image display apparatus according to the embodiment or an image captured by an external imaging device that is connected to the medical image display apparatus according to the embodiment is exemplified as the captured medical image according to the embodiment.

Each of the imaging device provided in the medical image display apparatus according to the embodiment and the external imaging device is arranged such that the space on the back side of the second display unit or the side of the display direction of the first display unit is captured. A space that includes, at least as a part, a space within a range of a viewing angle of the first display unit, for example, is exemplified as the space on the back side of the second display unit or the side of the display direction of the first display unit according to the embodiment. If an example of arrangement of the imaging device is exemplified, the imaging device provided in the medical image display apparatus according to the embodiment is arranged on a frame member that supports a display panel that forms the first display unit, for example. In addition, the external imaging device is arranged on a frame member that supports a display panel that forms the first display unit, for example.

The imaging device according to the embodiment includes, for example, an optical system and an image sensor using a plurality of imaging elements such as complementary metal oxide semiconductors (CMOSs), charge coupled devices (CCDs). The optical system includes, for example, one or two or more lenses such as an object lens, a zoom lens, and a focus lens and an optical element such as a mirror.

In addition, the imaging device according to the embodiment may have a configuration that has a pair of imaging elements, that is, a configuration that functions as a so-called stereo camera.

In addition, the imaging device according to the embodiment may have a configuration that can capture images with so-called high resolution such as 4K or 8K, for example. The medical image display apparatus according to the embodiment can have a display screen with a large size of 50 inches or greater or the like, for example, and can display a captured medical image while securing predetermined resolution (for example, full HD image quality or the like) even in a case in which the captured medical image is displayed on the entire display screen by the imaging device according to the embodiment being configured to be able to capture images with high resolution. Therefore, it is possible to improve visibility for a person who views the captured medical image that is displayed on the display screen of the medical image display apparatus according to the embodiment by the imaging device according to the embodiment having a configuration capable of capturing images with high resolution.

As described above, the captured medical image of the space on the back side of the second display unit or the side of the display direction of the first display unit is displayed on at least a part of the display screen of the second display unit in the medical image display apparatus according to the embodiment.

Therefore, the person who views the display screen of the second display unit can be aware of the space on the back side of the second display unit or the side of the display direction of the first display unit from the captured medical image that is displayed on the display screen of the second display unit even if the line of sight is obstructed by the medical image display apparatus according to the embodiment as represented by the reference numeral G in each of A of FIG. 1 to C of FIG. 1, for example.

If this is applied to a use case in which the medical image display apparatus according to the embodiment is used in a medical site such as an operating room, the medical professional who is on the side of the display screen of the second display unit of the medical image display apparatus according to the embodiment (the medical professional who is within the viewing angle of the second display unit) can be aware of a situation of a medical practice that is performed in the space on the back side of the second display unit or the side of the display direction of the first display unit by viewing the captured medical image that is displayed on the display screen of the second display unit. Therefore, it becomes easier for the medical professional who is on the side of the display screen of the second display unit of the medical image display apparatus according to the embodiment and the medical professional who is in the space on the side of the display direction of the first display unit of the medical image display apparatus according to the embodiment to maintain coordination with each other by using the medical image display apparatus according to the embodiment.

Therefore, the medical image display apparatus according to the embodiment can improve convenience.

Note that the image that is displayed on the display screen of the second display unit of the medical image display apparatus according to the embodiment is not limited to the captured medical image of the space on the back side of the second display unit or the side of the display direction of the first display unit.

For example, one or two or more of a medical-related image related to the captured medical image, a medical image that indicates a character string indicating a result of recognizing sound collected by a microphone, and a user interface image may be displayed along with the captured medical image of the space on the back side of the second display unit or the side of the display direction of the first display unit, on the display screen of the second display unit in the medical image display apparatus according to the embodiment.

A layout of images to be displayed on the display screen of the second display unit, a number of the images to be displayed on the display screen of the second display unit, and content of the images to be displayed on the display screen of the second display unit are respectively changed on the basis of user's operations. Here, touch operations (in a case in which the second display unit is a touch panel as will be described later) performed by an operating body such as a finger on the display screen of the second display unit, operations performed on an external operation device such as a remote controller, or the like are exemplified as the aforementioned user's operations, for example.

The medical-related image according to the embodiment is an image including content that has some relevance with an action that is performed in the space shown by the captured medical image of the space on the back side of the second display unit or the side of the display direction of the first display unit, for example.

If a case in which the captured medical image of the space on the back side of the second display unit or the side of the display direction of the first display unit is an image of a space at a location where a medical practice is performed is exemplified, for example, the medical-related image according to the embodiment is an image related to the medical practice. In addition, one of or both an image related to a patient who receives the medical practice and an image that shows a flow of the medical practice are exemplified as the image related to the medical practice.

The following examples are exemplified, for example, as the image related to the patient who receives the medical practice according to the embodiment. Note that it is needless to say that the image related to the patient who receives the medical practice according to the embodiment is not limited to the following examples.
An image that shows vital signs of the patient who receives the medical practice
A computed tomography (CT) image of the patient who receives the medical practice
A digital radiography (DR) image of the patient who receives the medical practice
An image that shows radiology information system (RIS) information corresponding to the patient who receives the medical practice
A captured medical image of an operating room where another operation (for example, transplantation or the like) related to the patient who receives the medical practice is performed

In addition, an image that shows a flow of an operation (an image that shows content of a written operation procedure in accordance with an operative method, for example), an image that shows a progress state of the flow of the operation or a technique in the operation, and the like is exemplified, for example, as the image that shows the flow of the medical practice according to the embodiment. Note that it is needless to say that the image that shows the flow of the medical practice according to the embodiment is not limited to the examples described above.

In addition, the character string that indicates a result of recognizing sound collected by the microphone according to the embodiment is a character string (including one character) that is obtained as a result of performing processing related to arbitrary sound recognition on sound collected by the microphone.

The sound recognition processing performed on the sound collected by the microphone may be performed by the medical image display apparatus (for example, by the control unit which will be described later) according to the embodiment or may be performed by an external device of the medical image display apparatus according to the embodiment. In addition, the microphone that collects the sound may be a microphone that is provided in the medical image display apparatus according to the embodiment or may be an external microphone of the medical image display apparatus according to the embodiment.

In addition, the user interface image according to the embodiment is an image through which a person who uses the medical image display apparatus according to the embodiment performs operations on the medical image display apparatus according to the embodiment.

An operation image for switching display content on the display screen of the second display unit is exemplified, for example, as the user interface image according to the embodiment. One or two or more of changing of a region where the image is to be displayed, switching of the image to be displayed, and cancellation of the display of the displayed image are exemplified, for example, as the switching of the display content on the display screen of the second display unit, which is realized by an operation image for switching the display content of the display screen of the second display unit.

In a case in which the user interface image according to the embodiment is an operation image for switching the display content of the display screen of the second display unit, and an operation is performed on the user interface image, for example, the display on the second display unit changes according to the operation performed on the user interface image.

Note that the example of the user interface image according to the embodiment is not limited to the examples described above.

For example, an operation image for reflecting the display content on the display screen of the second display unit in the display screen of the first display unit may be included in the user interface image according to the embodiment.

In a case in which the operation image for reflecting the display content on the display screen of the second display unit in the display screen of the first display unit is included in the user interface image according to the embodiment, and an operation is performed on the user interface image, for example, the display content on the second display unit is reflected in the display screen of the first display unit according to the operation performed on the user interface image. That is, in the case in which the operation image for reflecting the display content on the display screen of the second display unit in the display screen of the first display unit is included in the user interface image according to the embodiment, causing the display of the first display unit to change in a similar manner to that of the display of the second display unit can be realized, for example.

In addition, if a case in which the medical image display apparatus according to the embodiment is used in a medical scene such as an operating room is exemplified, an annotation image for providing annotation for a medical practice may be included in the user interface image according to the embodiment. “Providing orders and instructions to medical professionals such as practitioners during an operation”, for example, is realized by the annotation image for the medical practice included in the user interface image according to the embodiment.

Examples of an image displayed on the display screen of the first display unit and an image displayed on the display screen of the second display unit of the medical image display apparatus according to the embodiment will be described later.

### [2] Configuration of Medical Image Display Apparatus According to Embodiment

Next, an example of a configuration of the medical image display apparatus according to the embodiment will be described.

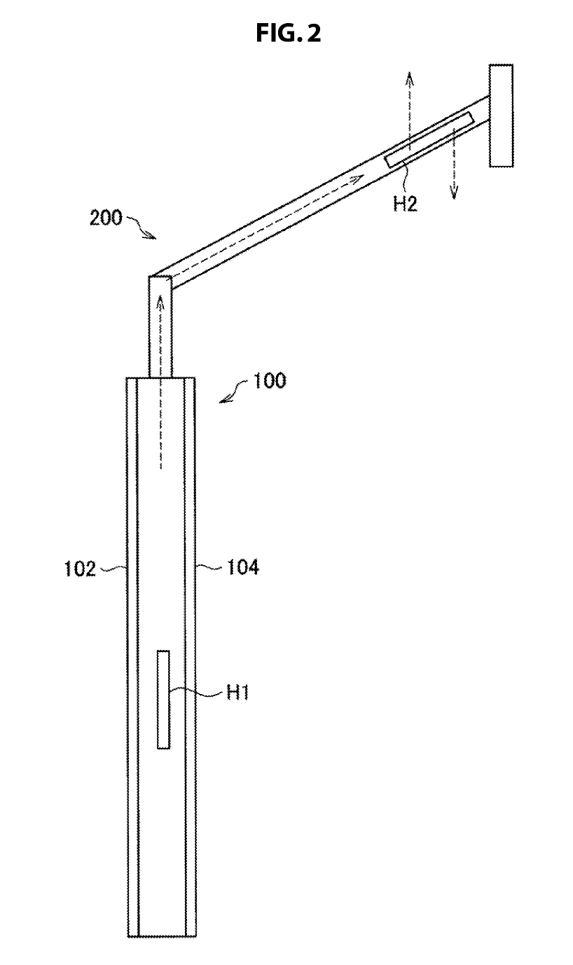

FIG. 2 is an explanatory diagram illustrating an example of an appearance of a medical image display apparatus 100 according to the embodiment. FIG. 2 illustrates an example in which the medical image display apparatus 100 is supported by a connection arm 200. The connection arm 200 plays a role in supporting the medical image display apparatus 100 such that the medical image display apparatus 100 is suspended from a ceiling portion of a space in an operating room or the like.

The medical image display apparatus 100 includes a first display unit 102 and a second display unit 104, for example. The example illustrated in FIG. 1 illustrates an example in which the first display unit 102 and the second display unit 104 are arranged such that the display direction of the first display unit 102 and the display direction of the second display unit 104 are opposite directions.

That is, in the medical image display apparatus 100 illustrated in FIG. 1, the display screen of the first display unit 102 corresponds to the display screen on the front surface of the medical image display apparatus 100 while the display screen of the second display unit 104 corresponds to the display screen on the back surface of the medical image display apparatus 100, for example. Note that the display screen of the second display unit 104 may correspond to the display screen on the front surface of the medical image display apparatus 100 while the display screen of the first display unit 102 may correspond to the display screen on the back surface of the medical image display apparatus 100, for example, in the medical image display apparatus 100 illustrated in FIG. 1. Hereinafter, a case in which a side on which the display screen of the first display unit 102 is provided corresponds to the front surface of the medical image display apparatus 100 that plays a role as a main display screen and a side on which the display screen of the second display unit 104 is provided corresponds to the back surface of the medical image display apparatus 100 that plays a role as a sub-display screen will be exemplified.

In the medical image display apparatus 100, an intake hole H1 is provided in a side surface of the medical image display apparatus 100, and an exhaust hole (not illustrated) is provided at a connection portion with a connection arm 200 of the medical image display apparatus 100. In addition, an exhaust hole H2 is provided at the connection arm 200. Note that an intake filter may be provided at the intake hole H1 of the medical image display apparatus 100, and an exhaust filter may be provided at each of the exhaust hole (not illustrated) of the medical image display apparatus 100 and the exhaust hole H2 of the connection arm 200.

The medical image display apparatus 100 takes air from the intake hole H1 and exhausts the air from the exhaust hole (not illustrated). The gas exhausted from the medical image display apparatus 100 is exhausted from the exhaust hole H2 at the connection arm 200 via a vent hole inside the connection arm 200.

The following effect is achieved by intake air and the exhaust air in the medical image display apparatus 100 performed as illustrated in FIG. 1, for example.
In a case in which the medical image display apparatus 100 is used in a medical scene such as an operating room, the possibility that the gas exhausted from the medical image display apparatus 100 sanitarily influences on a medical practice that is performed in the medical scene is further reduced.

The medical image display apparatus 100 is arranged in a space in an operating room or the like by being supported by the connection arm 200 as illustrated in FIG. 1, for example. Note that the method of arranging the medical image display apparatus 100 in the space is not limited to the method using the connection arm 200 as illustrated in FIG. 1. The medical image display apparatus 100 may be arranged in the space by an arbitrary member capable of supporting the medical image display apparatus 100, such as a stand, for example.

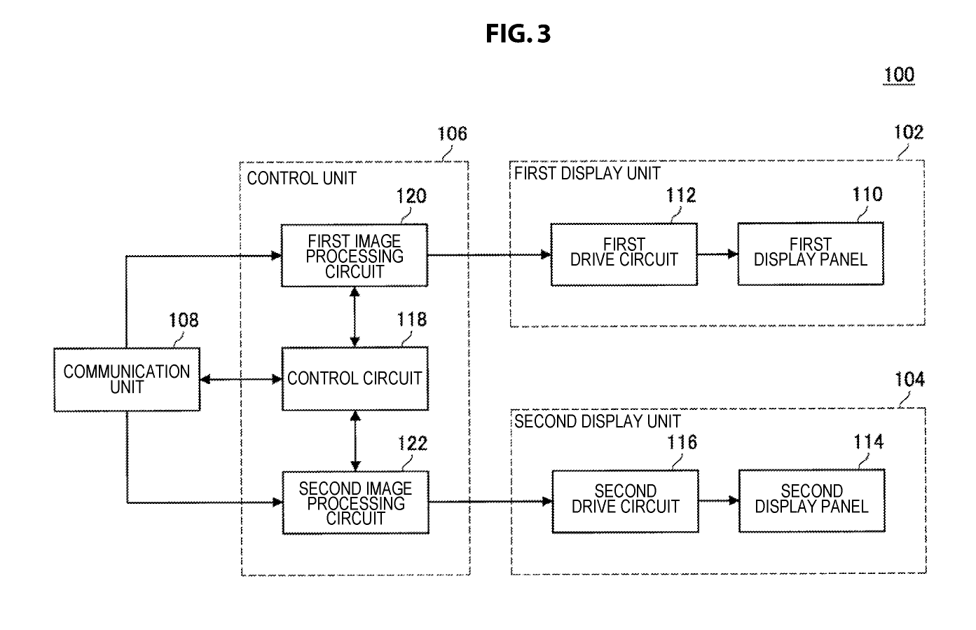

FIG. 3 is an explanatory diagram illustrating an example of a configuration of the medical image display apparatus 100 according to the embodiment. The medical image display apparatus 100 includes the first display unit 102, the second display unit 104, a control unit 106, and a communication unit 108, for example. For example, the medical image display apparatus 100 is driven by power supplied from an internal power source, such as a battery, provided in the medical image display apparatus 100, power supplied from an external power source connected thereto, or the like.

### [2-1] First Display Unit 102 and Second Display Unit 104

The first display unit 102 is one display section that is provided in the medical image display apparatus 100, and the second display unit 104 is the other display section that is provided in the medical image display apparatus 100. The first display unit 102 and the second display unit 104 are provided such that the display directions are mutually different as illustrated in FIG. 1, for example.

### [2-1-1] Example of Configuration of First Display Unit 102

The first display unit 102 includes a first display panel 110 and a first drive circuit 112, for example.

The first display panel 110 has a plurality of pixel circuits, for example, and causes the display screen to display an image based on supplied display data. The respective pixel circuits that form the first display panel 110 are arranged in a matrix shape at intersecting portions between control lines disposed in rows and signal lines disposed in columns. The number of pixel circuits, the number of control lines, and the number of signal lines that form the first display panel 110 correspond to resolution or the like that the first display unit 102 handles, for example.

Pixel circuits that include liquid crystal elements and drive transistors and pixel circuits that include arbitrary light emitting elements that emit light by a current flowing and drive transistors are exemplified, for example, as the pixel circuits that form the first display panel 110. Arbitrary light emitting elements that emit light by a current flowing, such as an organic electroluminescence (EL) elements and inorganic EL element, are exemplified, for example, as the light emitting element according to the embodiment.

The first display panel 110 employs a configuration that is compatible with an arbitrary display scheme capable of displaying an image on the display screen, such as a configuration that is compatible with a liquid crystal display, a configuration that is compatible with an organic EL display, or a configuration that is compatible with an inorganic EL display. Hereinafter, a case in which the first display panel 110 has a configuration that is compatible with the liquid crystal display will mainly be exemplified.

The first drive circuit 112 causes a pixel circuit that forms the first display panel 110 to drive.

The first drive circuit 112 has a scan driver and a data driver, for example, and controls update of display data in the pixel circuit, compensation of a threshold voltage of a drive transistor, light emission from the light emitting elements, and the like.

The scan driver that the first drive circuit 112 has is electrically connected to the control lines and selectively supplies control signals to the control lines. One or two or more control lines for realizing functions that the first display panel 110 has, such as control lines for controlling update timing of the display data, control lines for controlling circuit disconnection switch timing at which a display data update circuit and a drive transistor threshold voltage compensation circuit that form the pixel circuits are disconnected, and control lines for controlling pixel circuit initialization timing, are exemplified, for example, as the control lines to which the scan driver that the first drive circuit 112 has is electrically connected. The scan driver that the first drive circuit 112 has supplies respectively corresponding control signals to the various control lines electrically connected thereto at a predetermined timing.

The data driver that the first drive circuit 112 has is electrically connected to signal lines and selectively supplies display data to the signal lines. Here, the display data is delivered from the control unit 106 (more specifically, a first image processing circuit 120, which will be described later, for example), for example.

The first display unit 102 includes the first display panel 110 and the first drive circuit 112 that have the configurations as described above, for example.

The configuration of the first display unit 102 is not limited to the example described above.

For example, the first display unit 102 may include a timing controller (not illustrated) that controls a processing timing (for example, a processing timing in a scan driver and a data driver that form the first drive circuit 112) in the first drive circuit 112. In addition, in a case in which the first display unit 102 includes the timing controller (not illustrated), the timing controller may further control a processing timing in the second display unit 104.

### [2-1-2] Example of Configuration of Second Display Unit 104

The second display unit 104 includes, for example, a second display panel 114 and a second drive circuit 116.

The second display panel 114 has a plurality of pixel circuits in the similar manner to that of the first display panel 110, for example, and causes the display screen to display an image based on supplied display data. The respective pixel circuits that form the second display panel 114 are arranged in a matrix form at the intersecting portions between the control lines disposed in rows and the signal lines disposed in columns, for example. The number of pixel circuits, the number of control lines, and the number of signal lines that form the second display panel 114 correspond to resolution that the second display unit 104 handles, for example.

Here, the same numbers as the number of pixel circuits, the number of control lines, and the number of signal lines that form the first display panel 110, for example, are exemplified as the number of pixel circuits, the number of control lines, and the number of signal lines that form the second display panel 114, respectively. In addition, the number of pixel circuits, the number of control lines, and the number of signal lines that form the second display panel 114 may be different from the number of pixel circuits, the number of control lines, and the number of signal lines that form the first display panel 110, respectively.

That is, the resolution of the display screen of the first display unit 102 and the resolution of the display screen of the second display unit 104 may be the same or may be different in the medical image display apparatus 100. If a specific example of the case in which the resolution of the display screen of the first display unit 102 and the resolution of the display screen of the second display unit 104 are different is exemplified, “the resolution of the display screen of the second display unit 104 being smaller than the resolution of the displays screen of the first display unit 102” or “the resolution of the display screen of the first display unit 102 being smaller than the resolution of the display screen of the second display unit 104” is exemplified.

Pixel circuits that include liquid crystal elements and drive transistors and pixel circuits that include arbitrary light emitting elements that emit light by a current flowing and drive transistors are exemplified as the pixel circuits that form the second display panel 114 in a similar manner to that of the first display panel 110, for example. The pixel circuits that form the second display panel 114 and the pixel circuits that form the first display panel 110 may have the same configurations or may have different configurations.

The second display panel 114 employs a configuration that is compatible with an arbitrary display scheme capable of displaying an image on the display screen, such as a configuration that is compatible with a liquid crystal display, a configuration that is compatible with an organic EL display, or a configuration that is compatible with an inorganic EL display in a similar manner to that of the first display panel 110. Hereinafter, a case in which the second display panel 114 has the configuration that is compatible with the liquid crystal display will be mainly exemplified.

The second drive circuit 116 drives the pixel circuits that form the second display panel 114.

The second drive circuit 116 has a scan driver and a data driver in a similar manner to that of the first drive circuit 112, for example, and controls update of display data in the pixel circuit, compensation of a threshold voltage of a drive transistor, light emission from light emitting elements, and the like.

The scan driver that the second drive circuit 116 has is electrically connected to the control lines and selectively supplies control signal to the control lines. One or two or more control lines for realizing the functions that the second display panel 114 has are exemplified as the control lines to which the scan driver that the second drive circuit 116 has are electrically connected in a similar manner to that of the scan driver that the first drive circuit 112, for example. The scan driver that the second drive circuit 116 has supplies the respectively corresponding control signals to the various control lines electrically connected at a predetermined timing.

The data driver that the second drive circuit 116 has is electrically connected to the signal lines and selectively supplies display data to the signal lines. Here, the display data is delivered from the control unit 106 (more specifically, a second image processing circuit 112, which will be described later, for example), for example.

The second display unit 103 includes the second display panel 114 and the second drive circuit 116 that have the configuration as described above, for example.

The configuration of the second display unit 104 is not limited to the example described above.

For example, the second display unit 104 may include a timing controller (not illustrated) that controls a processing timing in the second drive circuit 116 (a processing timing in the scan driver and the data driver that form the second drive circuit 116, for example). In addition, the timing controller may further control a processing timing in the first display unit 102 in a case in which the second display unit 104 includes the timing controller (not illustrated).

### [2-1-3] Implementation Examples of First Display Unit 102 and Second Display Unit 104

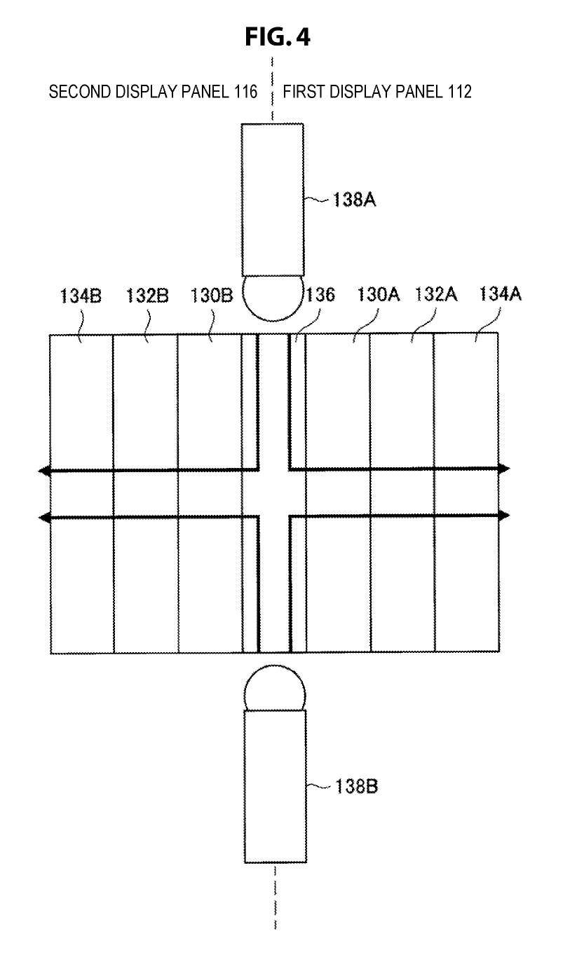

Here, implementation examples of the first display unit 102 and the second display unit 104 will be described. FIG. 4 is an explanatory diagram schematically illustrating configurations of the first display panel 110 included in the first display unit 102 and the second display panel 114 included in the second display unit provided in the medical image display apparatus 100 according to the embodiment. FIG. 4 illustrates an example of a configuration in a case in which the medical image display apparatus 100 is a liquid crystal display.

The first display panel 110 has a liquid crystal layer 130A, a color filter 132A, and a polarization filter 134A. In addition, the second display panel 114 has a liquid crystal layer 130B, a color filter 132B, and a polarization filter 134B.

A light guiding panel 136 is provided between the first display panel 110 and the second display panel 114, and light is incident on the light guiding panel 136 from a light source 138A and a light source 138B, respectively. Light emitting diodes (LEDs) or the like are exemplified, for example, as the light sources 138A and 138B.

The light that is incident on the light guiding panel 136 from the light sources 138A and 138B, respectively is diffused by the light guiding panel 136 and is incident on the first display panel 110 and the second display panel 114, respectively.

Accordingly, images can be displayed on each of the display screen of the first display unit 102 and the display screen of the second display unit 104 in the medical image display apparatus 100 that has the configuration illustrated in FIG. 4.

In addition, the first display unit 102 and the second display unit 104 share the light sources 138A and 138B in the medical image display apparatus 100 that has the configuration illustrated in FIG. 4. Here, power consumed by the light sources is high, and heat generation in the light sources is large in the medical image display apparatus that has the light sources. Therefore, the medical image display apparatus 100 that has the configuration illustrated in FIG. 4 has an advantage that “power consumption can be suppressed to the similar extent to that of a medical image display apparatus provided with one display unit, with the configuration provided with two display units and a measure for heat is sufficient if a heat discharge mechanism with performance to the similar extent to that of the medical image display apparatus provided with one display unit is provided”.

Note that the implementation examples of the first display unit 102 and the second display unit 104 are not limited to the examples illustrated in FIG. 4.

For example, although FIG. 4 illustrates the example in which the sizes of the first display panel 110 and the second display panel 114 are the same, that is, the example in which the size of the display screen of the first display unit 102 and the size of the display screen of the second display unit 104 are the same, the size of the display screen of the first display unit 102 and the size of the display screen of the second display unit 104 may be different. If a specific example of the case in which the size of the display screen of the first display unit 102 and the size of the display screen of the second display unit 104 are different is exemplified, “the size of the display screen of the second display unit 104 being smaller than the size of the display screen of the first display unit 102” or “the size of the display screen of the first display unit 102 being smaller than the size of the display screen of the second display unit 104” is exemplified.

In addition, a sensor for detecting operations performed on the display screens by an operation body, such as a finger, for example, may be provided at one of or both the second display panel 110 that forms the first display unit 102 and the second display panel 114 that forms the second display unit 104. A sensor of an arbitrary detection scheme capable of detecting operations performed on the display screens, such as a sensor for detecting operations performed on the display screens by a mutual capacitance scheme is exemplified, for example, as the aforementioned sensor. That is, one of or both the first display nit 102 and the second display unit 104 may be a touch panel in the medical image display apparatus 100.

In addition, although FIG. 4 illustrates an example in which the light sources are shared by the first display unit 102 and the second display unit 104, the medical image display apparatus 100 may have a configuration in which corresponding light sources are respectively provided in the first display unit 102 and the second display unit 104.

In addition, although FIG. 4 illustrates an example in which the first display panel 110 that forms the first display unit 102 and the second display panel 114 that forms the second display unit 104 have the same configurations, the configuration of the first display panel 110 and the configuration of the second display panel 114 may be different in the medical display apparatus 100. That is, the medical image display apparatus can employ a configuration in which the first display unit 102 and the second display unit 104 use mutually different display schemes.

### [2-2] Control Unit 106

Referring to FIG. 3 again, an example of the configuration of the medical image display apparatus 100 will be described. The control unit 106 plays a role in initiatively performing processing related to the display control method according to the embodiment and controls display on the respective display screens of the first display unit 102 and the second display unit 104.

The control unit 106 controls the display on the respective display screens of the first display unit 102 and the second display unit 104 by delivering the signals for controlling the display on the display screens and display data indicating images to be displayed on the display screens to each of the first display unit 102 and the second display unit 104, for example. Signals for defining a processing timing in the first drive circuit 112 of the first display unit 102 are exemplified, for example, as the signal for controlling the display on the display screen of the first display unit. In addition, signals for defining a processing timing in the second drive circuit 116 of the second display unit 104 is exemplified, for example, as the signals for controlling the display on the display screen of the second display unit 104. Note that the signals for controlling the display on the display screens according to the embodiment are not limited to the examples described above and may be arbitrary signals capable of controlling the display on the respective display screens of the first display unit 102 and the second display unit 104.

The control unit 106 controls the display on the display screen of the second display unit 104 such that the captured medical image of the space on the side of the display direction of the first display unit 102 is displayed on at least a part of the display screen of the second display unit 104, for example. As described above, displaying the captured medical image on the entire display screen of the second display unit 104 and displaying the captured medical image in a region as a part of the display screen of the second display unit 104 are included in displaying the captured medical image on at least a part of the display screen of the second display unit 104 as described above.

Note that the processing related to the display control method performed by the control unit 106 is not limited to the example described above.

For example, the control unit 106 can also causes the display screen of the second display unit 104 to display one or two or more of a medical-related image related to the captured medical image, a medical image that indicates a character string indicating a result of recognizing sound collected by a microphone, and a user interface image along with the captured medical image of the space on the side of the display direction of the first display unit 102.

If an example is exemplified, the control unit 106 performs processing related to arbitrary sound recognition on sound collected by the microphone and obtains a character string indicating a result of recognizing the sound collected by the microphone. Then, the control unit 106 causes the display screen of the second display unit 104 to display a medical image that indicates the character string indicating the result of recognizing the sound collected by the microphone along with the captured medical image of the space on the side of the display direction of the first display unit 102.

Examples of processing related to the display control method performed by the control unit 106 and display examples on the respective display screens of the first display unit 102 and the second display unit 104, which are realized by the processing related to the display control method performed by the control unit 106, will be described later.

The control unit 106 has the control circuit 116, the first image processing circuit 120, and the second image processing circuit 122, for example.

The control circuit 118 plays a role in initiatively performing control of the display on the respective display screens of the first display unit 102 and the second display unit 104.

If an example is exemplified, the control circuit 118 controls execution of processing by each of the first image processing circuit 120 and the second image processing circuit 122. If another example is exemplified, the control circuit 118 controls a processing timing in the scan driver and the data driver that form the first drive circuit 112 and a processing timing in the scan driver and the data driver that form the second drive circuit 116, respectively. That is, the control circuit 118 may play a role as a timing controller in the medical image display apparatus 100.

In addition, the control circuit 118 may play a role in controlling the entire medical image display apparatus 100.

If an example of control performed in a case in which the control circuit 118 plays a role in controlling the entire medical image display apparatus 100 is exemplified, the control circuit 118 controls communication performed by the communication unit 108, for example. In addition, if another example is exemplified, the control circuit 118 controls image capturing by the imaging device (which will be described later) provided in the medical image display apparatus 100 or the external imaging device of the medical image display apparatus. Further, the control circuit 118 may control sound collection by the microphone (which will be described later) provide in the medical image display apparatus 100 or by the external microphone of the medical image display apparatus 100, for example.

The control circuit 118 includes one or two or more processors that include a computation circuit such as a micro-processing unit (MPU), for example. Note that the aforementioned processor that functions as the control circuit 118 may further function as one of or both the first image processing circuit 120 and the second image processing circuit 122.

The first image processing circuit 120 performs predetermined image processing on image signals such as image signals delivered from the communication unit 108 and image signals indicating the captured medical image delivered from the imaging device (which will be described later) provided in the medical image display apparatus 100, for example, and generates display data for causing the display screen of the first display unit 102 to display an image. Then, the first image processing circuit 120 delivers the generated display data to the first drive circuit 112 of the first display unit 102.

One or two or more types of processing from among arbitrary types of processing performed on the image, such as gamma correction, white balance adjustment, enlargement or reduction of the image related to an electronic zooming function, and correction between pixels are exemplified, for example, as the image processing performed by the first image processing circuit 120.

The second image processing circuit 122 performs predetermined image processing on image signals such as image signals delivered from the communication unit 108 and image signals indicating the captured medical image delivered from the imaging device (which will be described later) provided in the medical image display apparatus 100, for example, and generates display data for causing the display screen of the second display unit 104 to display an image. Then, the second image processing circuit 122 delivers the generated display data to the second drive circuit 116 of the second display unit 104.

One or two or more types of processing from among arbitrary types of processing performed on the image, such as gamma correction, white balance adjustment, enlargement or reduction of the image related to an electronic zooming function, and correction between pixels are exemplified, for example, as the image processing performed by the second image processing circuit 122. Image processing functions that the second image processing circuit 122 has may be the same as or different from the image processing functions that the first image processing circuit 120 has.

The control unit 106 has the control circuit 118, the first image processing circuit 120, and the second image processing circuit 122, for example, thereby controlling the display on the respective display screens of the first display unit 102 and the second display unit 104. One example of the display on each of the display screen of the first display unit 102 and the display screen of the second display unit 104 which are realized by the control of the control unit 106 will be described later.

Note that the configuration of the control unit 106 is not limited to the example illustrated in FIG. 4 and may be an arbitrary configuration capable of controlling the display on the respective display screens of the first display unit 102 and the second display unit 104.

### [2-3] Communication Unit 108

The communication unit 108 is a communication section provided in the medical image display apparatus 100 and plays a role in performing wireless or wired communication with external devices such as an external imaging device, a medical controller, a server, an external microphone, and an external recording device.

The communication unit 108 includes a communication device (not illustrated), for example, and the communication performed by the communication unit 108 is controlled by the control unit 106, for example. Here, devices that are compatible with arbitrary communication schemes, such as an IEEE802.15.1 port and a transmission and reception circuit (wireless communication), an IEEE802.11 port and a transmission and reception circuit (wireless communication), a communication antenna and a radio frequency (RF) circuit (wireless communication), or a local area network (LAN) terminal and a transmission and reception circuit (wired communication) are exemplified, for example, as the communication device (not illustrated). In addition, the communication unit 108 may include a plurality of communication devices (not illustrated).

In a case in which the communication unit 108 receives a signal that indicates an image transmitted from an external device, for example, the signal that indicates the image is processed by the control unit 106. Then, the corresponding image is displayed on the respective display screens of the first display unit 102 and the second display unit 104 by the display control of the control unit 106 in the medical image display apparatus 100.

The image is displayed on the respective display screens of the first display unit 102 and the second display unit 104 by the configuration illustrated in FIG. 3, for example, in the medical image display apparatus 100.

Here, the captured medical image of the space on the side of the display direction of the first display unit 102 is displayed on at least a part of the display screen of the second display unit 104 in the medical image display apparatus 100 as described above. Therefore, a person who views the display screen of the second display unit 104 can grasp the space on the side of the display direction of the first display unit 102 by the captured medical image that is displayed on the display screen of the second display unit 104 even if a line of sight is obstructed by the medical image display apparatus 100 as illustrated by the reference numeral G in each of A of FIG. 1 to C of FIG. 1, for example.

Therefore, the medical image display apparatus 100 can improve convenience.

Note that the configuration of the medical image display apparatus according to the embodiment is not limited to the example illustrated in FIG. 3.

For example, the medical image display apparatus according to the embodiment may include an imaging device that captures an image of the space on the side of the display direction of the first display unit 102. In a case in which the imaging device is included, the aforementioned imaging device functions as an imaging unit (not illustrated) that plays a role in capturing images in the medical image display apparatus according to the embodiment. In a case in which the aforementioned imaging device is included, an image captured by the imaging device provided in the medical image display apparatus according to the embodiment is included in the captured medical image that is displayed on at least a part of the display screen of the second display unit 104.

In addition, the medical image display apparatus according to the embodiment may include a microphone, for example. In a case in which the aforementioned microphone is included, the aforementioned microphone functions as a sound collecting unit (not illustrated) that plays a role in performing sound collection in the medical image display apparatus according to the embodiment. In a case in which the aforementioned microphone is included, a medical image that indicates a character string indicating a result of recognizing sound collected by the aforementioned microphone may be displayed on the display screen of the second display unit 104 as will be described later. Processing related to the recognition of the sound collected by the aforementioned microphone is performed by the control circuit 118 that forms the control unit 106 provided in the medical image display apparatus according to the embodiment, for example. In addition, the processing related to the recognition of the sound collected by the aforementioned microphone may be performed by an external device of the medical image display apparatus according to the embodiment, and the control unit 106 provided in the medical image display apparatus according to the embodiment may perform the display control by using data indicating a result of the sound recognition performed by the external device.

In addition, the medical image display apparatus according to the embodiment includes one of or both an output terminal that outputs an image indicating display content that is displayed on the display screen of the second display unit 104 and an output terminal that outputs an image indicating display content that is displayed on the display screen of the first display unit 102. Outputs of images from the output terminals as described above are controlled by the control circuit 118 of the control unit 106, for example.

The following matters are realized, for example, by the medical image display apparatus according to the embodiment including the output terminals as described above.
It is possible to cause an external recording medium of the medical image display apparatus according to the embodiment to store one of or both an image that indicates display content displayed on the display screen of the second display unit 104 and an image that indicates display content displayed on the display screen of the first display unit 102 (in a case in which an output destination is the external recording medium).
It is possible to cause an external display device of the medical image display apparatus according to the embodiment to display one of or both the image that indicates the display content displayed on the display screen of the second display unit 104 and the image that indicates the display content displayed on the display screen of the first display unit 102 (in a case in which the output destination is the external display device).

If a case in which the medical image display apparatus according to the embodiment is used in an operating room (an example of a medical scene) is exemplified, image data that indicates a situation of an operation, for example, is stored in an external recording medium in a case in which the output terminal is the output recording medium as described above. The image data stored in the external recording medium can be used for education or the like of medical professionals such as practitioners, for example.

In addition, in a case in which communication is performed with an external device via an external communication device that has a similar functions and a configuration of those of the communication unit 108, for example, or in a case in which operation is performed in a stand-alone fashion, the medical image display apparatus according to the embodiment may not include the communication unit 108.

In addition, in a case in which the display on the respective display screens of the first display unit 102 and the second display unit 104 is controlled by an external processor (or an external device that includes the processor) that has similar functions and a configuration as those of the control unit 106, for example, the medical image display apparatus according to the embodiment may not include the control unit 106. In the case in which the medial image display apparatus according to the embodiment does not include the control unit 106, the display examples on the respective display screens of the first display unit 102 and the second display unit 104, which will be described later, are realized by a system that includes the medical image display apparatus according to the embodiment and an external processor (or an external display control device that includes the processor) that has similar functions and a configuration to those of the control unit 106.

### [3] Display Examples in Medical Image Display Apparatus According to Embodiment

Next, display examples in medical image display apparatus according to the embodiment will be described. Hereinafter, display examples on the respective display screens of the first display unit 102 and the second display unit 104 will be exemplified while the medical image display apparatus 100 described above with reference to FIGS. 2 to 4 is exemplified. In addition, hereinafter, the display examples on the respective display screens of the first display unit 102 and the second display unit 104 in a case in which the medical image display apparatus according to the embodiment is used in an operating room (an example of a medical scene) will be described.

### [3-1] First Display Example: Display Example on Display Screen of First Display Unit 102

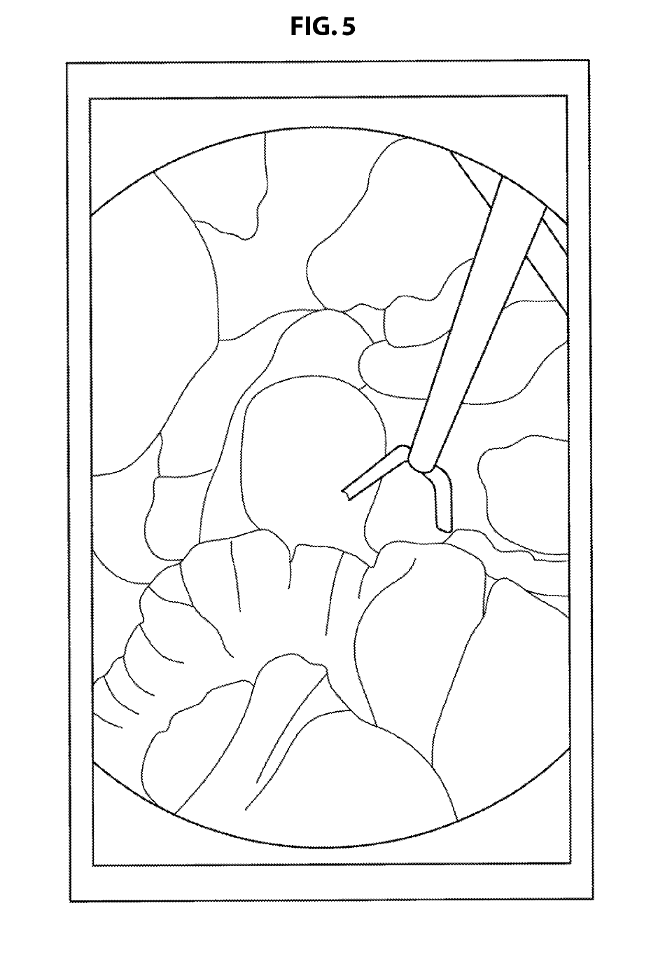

FIG. 5 is an explanatory diagram illustrating a first display example in the medical image display apparatus 100 according to the embodiment and illustrates an example of an image displayed on the display screen of the first display unit 102.

On the display screen of the first display unit 102, various images related to medical practices, such as a captured medical image captured by an endoscope apparatus or a captured medical image captured by an electronic imaging-type medical observation apparatus, for example, are displayed, for example. FIG. 5 illustrates an example of the captured medical image captured by the endoscope apparatus.

### [3-2] Second Display Example: First Display Example on Display Screen of Second Display Unit 104

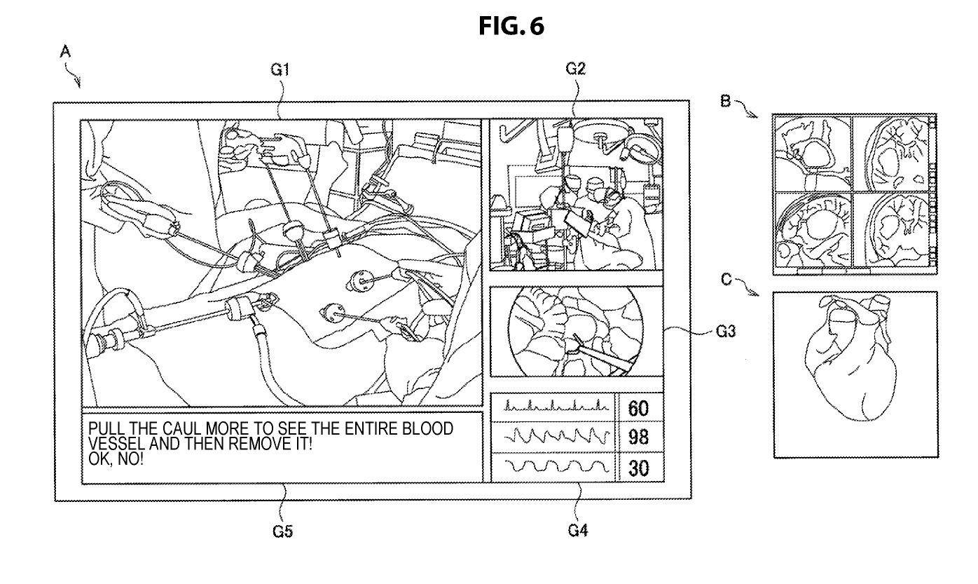

FIG. 6 is an explanatory diagram illustrating a second display example in the medical image display apparatus 100 according to the embodiment. A of FIG. 6 illustrates a first example of images displayed on the display screen of the second display unit 104. Also, B of FIG. 6 and C of FIG. 6 illustrate examples of images that can be displayed on the display screen of the second display unit 104.

On the display screen of the second display unit 104 illustrated in A of FIG. 6, the images represented by the reference numerals G1 to G5, for example, are displayed. The image G1 illustrates an example of a captured medical image of a space on the side of the display direction of the first display unit 102. In addition, the images G2 to G4 respectively illustrate examples of images related to a medical practice (examples of medical-related images related to the captured medical image). In addition, the image G5 illustrates an example of a medical image that indicates a character string indicating a result of recognizing sound collected by a microphone.

That is, A of FIG. 6 illustrates an example in which the medical-related image related to the captured medical image of the space on the side of the display direction of the first display unit 102 and the medical image that indicates the character string indicating the result of recognizing sound collected by the microphone are displayed with the captured medical image on the display screen of the second display unit 104.

In addition, the region in which the respective images illustrated in A of FIG. 6 are displayed may be able to be changed on the basis of a user's operation such as a touch operation performed with an operation body, such as a finger, on the display screen of the second display unit 104 (in a case in which the second display unit 104 is a touch panel) or an operation performed on an external device such as a remote controller, for example. That is, the person who uses the medical image display apparatus 100 can arbitrarily change the layout of the display screen of the second display unit 104 by the operation as described above.

In addition, the respective images G2 to G5 illustrated in A of FIG. 6 that are displayed on the display screen of the second display unit 104 may be switched with other images such as the image illustrated in B of FIG. 6 or the image illustrated in C of FIG. 6 on the basis of the user's operation as described above. Further, display of the respective images G2 to G5 illustrated in A of FIG. 6 that are displayed on the display screen of the second display unit 104 may be cancelled by the user's operation as described above. That is, the person who uses the medical image display apparatus 100 can arbitrarily change each of the number of images to be displayed on the display screen of the second display unit 104 and content of the images to be displayed on the display screen of the second display unit 104 by the operation as described above.

### [3-3] Third Display Example: Second Display Example on Display Screen of Second Display Unit 104

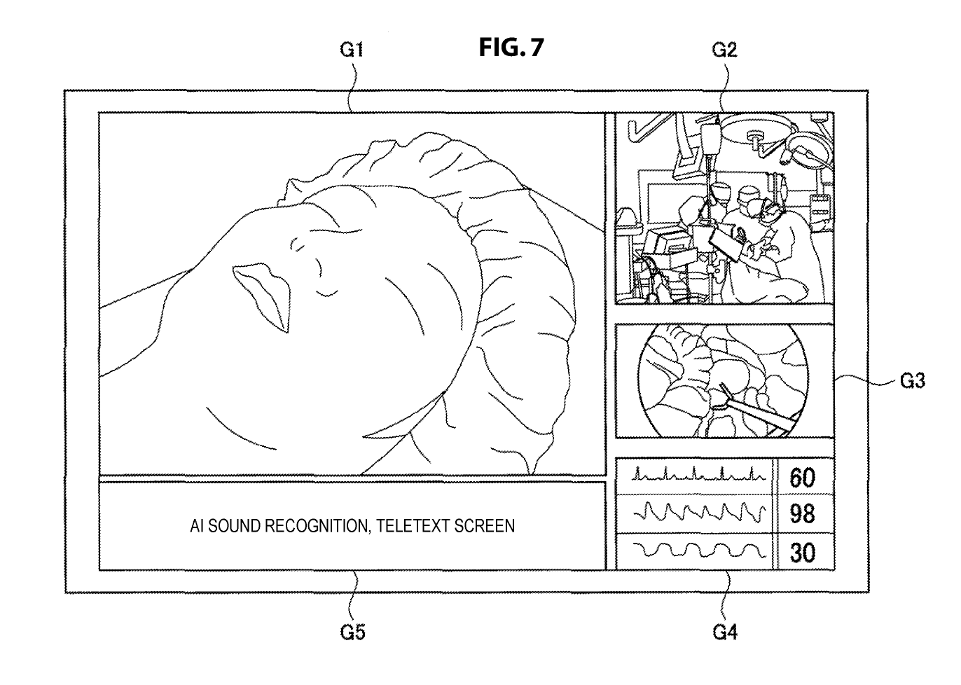

FIG. 7 is an explanatory diagram illustrating a third display example in the medical image display apparatus 100 according to the embodiment. FIG. 7 illustrates a second example of images displayed on the display screen of the second display unit 104.

On the display screen of the second display unit 104 illustrated in FIG. 7, the images represented by the reference numerals G1 to G5, for example, are displayed. The image G1 illustrates an example of a captured medical image of a space on the side of the display direction of the first display unit 102. In addition, the images G2 to G4 respectively illustrate examples of images related to a medical practice (examples of medical-related images related to the captured medical image). In addition, the image G5 illustrates an example of an image in which a character string indicating a result of recognizing sound collected by a microphone is displayed. That is, FIG. 7 illustrates another example in which the medial-related image related to the captured medical image of the space on the side of the display direction of the first display unit 102 and the medical image that indicates the character string indicating the result of recognizing the sound collected by the microphone are displayed with the captured medical image on the display screen of the second display unit 104.

It is possible to check a condition of a patient and vital signs of the patient if the display screen on the second display unit 104 is viewed, by the captured medical image (the image G1 illustrated in FIG. 7) including the face of the patient who receives the medical practice and the image that indicates the vital signs of the patient (the image G4 illustrated in FIG. 7) being displayed on the display screen of the second display unit 104 as illustrated in FIG. 7, for example. Therefore, the display as illustrated in FIG. 7 in the medical image display apparatus 100 is suitable for display for an anesthesiologist (an example of a medical professional, for example).

### [3-4] Fourth Display Example: Third Display Example on Display Screen of Second Display Unit 104

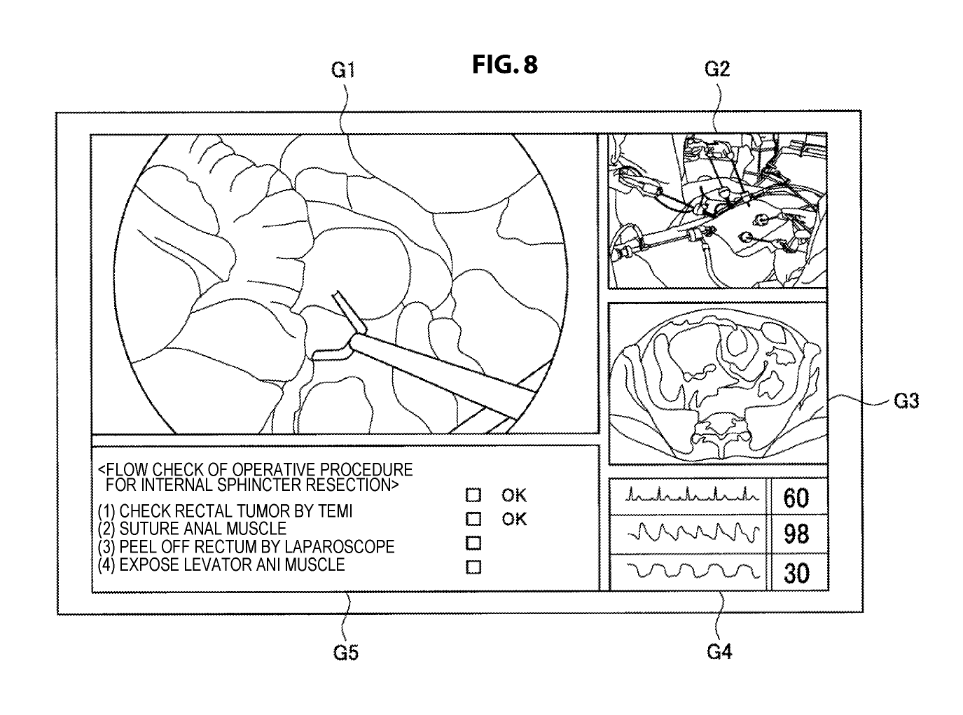

FIG. 8 is an explanatory diagram illustrating a fourth display example in the medical image display apparatus 100 according to the embodiment. FIG. 8 illustrates a third example of images displayed on the display screen of the second display unit 104.

On the display screen of the second display unit 104 illustrated in FIG. 8, the images represented by the reference numerals G1 to G5, for example, are displayed. The image G2 illustrates an example of a captured medical image of a space on the side of the display direction of the first display unit 102. In addition, the images G1 and G3 to G5 respectively represent examples of images related to a medical practice (examples of medical-related images related to the captured medical image). The images G1, G3, and G4 illustrate examples of images related to a patient who receives the medical practice, and the image G5 illustrates an image that indicates a flow of an operation and a progress state of a technique in the operation (an example of an image that indicates a flow of the medical practice). That is, FIG. 8 illustrates another example in which the medical-related image related to the captured medical image of the space on the side of the display direction of the first display unit 102 is displayed with the captured medical image on the display screen of the second display unit 104.

The progress state of the technique in the image that indicates the flow of the operation and the progress state of the technique in the operation, which is illustrated in the image G5 in FIG. 8, is updated on the basis of a user's operation such as a touch operation performed with an operation body such as a finger on the display screen of the second display unit 104 (in a case in which the second display unit 104 is a touch panel) or an operation performed on an external operation device such as a remote controller, for example.

### [3-5] Fifth Display Example: First Display Example Related to Coordination Between Display Screen of Second Display Unit 104 and Display Screen of First Display Unit 102

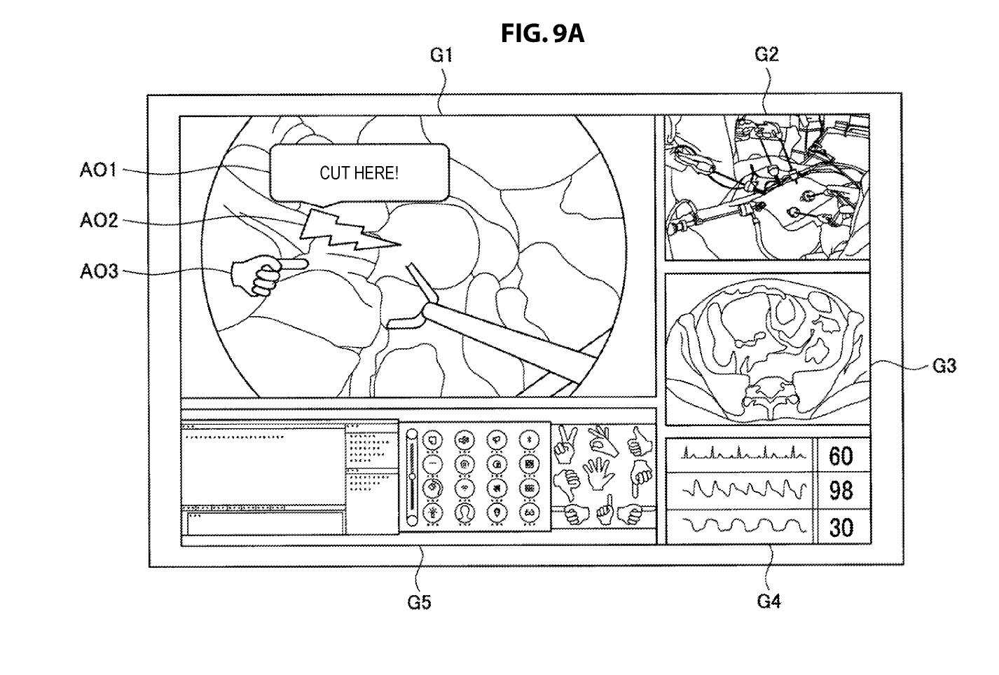

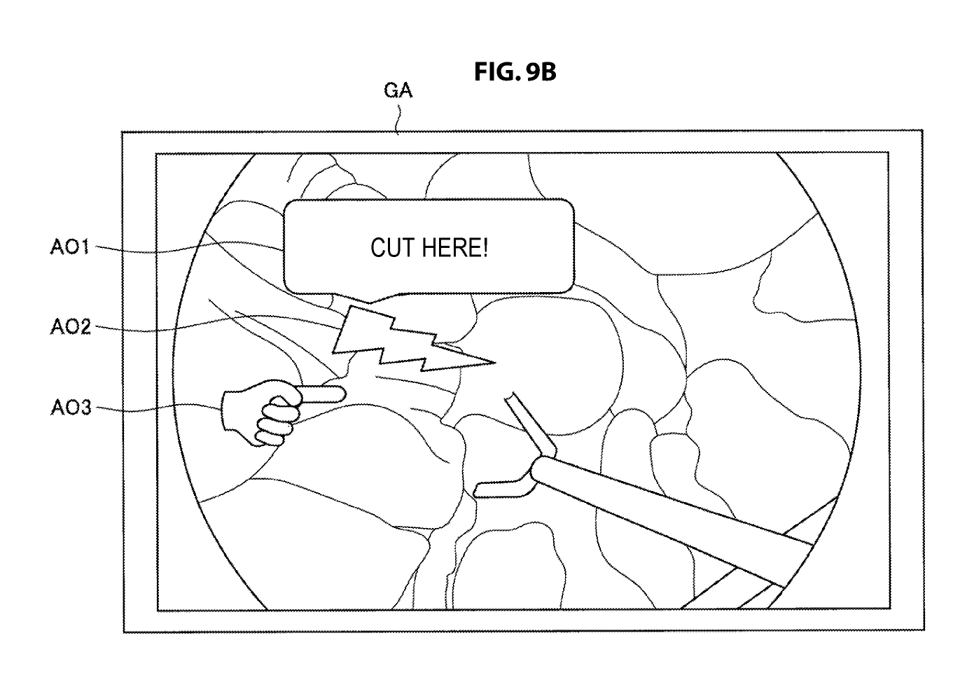

FIGS. 9A and 9B are explanatory diagrams illustrating a fifth display example in the medical image display apparatus 100 according to the embodiment. FIG. 9A illustrates an example of display of images that are displayed on the display screen of the second display unit 104. In addition, FIG. 9B illustrates an example of display of an image that is displayed on the display screen of the first display unit 102 in accordance with a change in the display on the display screen of the second display unit 104 illustrated in FIG. 9A.

On the display screen of the second display unit 104 illustrated in FIG. 9A, the images represented by the reference numerals G1 to G5 are displayed, for example. The image G2 illustrates an example of a captured medical image of a space on the side of the display direction of the first display unit 102. In addition, the images G1, G3, and G4 respectively illustrate examples of images related to the medical practice (examples of the medical-related image related to the captured medical image). In addition, the image G5 illustrates an example of an annotation image for the medical practice (an example of a user interface image). That is, FIG. 9A illustrates an example in which the medical-related image related to the captured medical image of the space on the side of the display direction of the first display unit 102 and the user interface image are displayed with the captured medical image on the display screen of the second display unit 104.

The person who uses the medical image display apparatus 100 can add an annotation object to an image that is displayed on the display screen of the second display unit 104 by performing a user's operation on the image G5 in FIG. 9A, for example. One of or both an object including a character string and an icon are exemplified, for example, as the annotation object according to the embodiment. FIG. 9A illustrates an example in which an object including a character string (AO1 illustrated in FIG. 9A) and icons (AO2 and AO3 illustrated in FIG. 9A) have been added as annotation objects to the image G1 in FIG. 9A, for example.

If the annotation objects AO1 to AO3 are added to the image displayed on the display screen of the second display unit 104 as illustrated in FIG. 9A, for example, the annotation objects AO1 to AO3 are added to the image that is displayed on the display screen of the first display unit 102 as illustrated in FIG. 9B in the medical image display apparatus 100. That is, display content of the second display unit 104 is reflected in the display screen of the first display unit 102 according to an operation performed on the annotation image (an example of a user interface image) as illustrated in the image G5 in FIG. 9A in the medical image display apparatus 100.

It is possible to realize “an instruction by a person who provides instructions to a practitioner, such as a supervisory doctor, when the practitioner performs a technique”, for example, by the display content of the second display unit 104 being reflected in the display screen of the first display unit 102 as illustrated in FIGS. 9A and 9B. That is, the medical image display apparatus 100 that has a function with which the display content of the second display unit 104 is reflected in the display screen of the first display unit 102 can be used for the purpose of education.

### [3-6] Sixth Display Example: Second Display Example Related to Coordination Between Display Screen of Second Display Unit 104 and Display Screen of First Display Unit 102

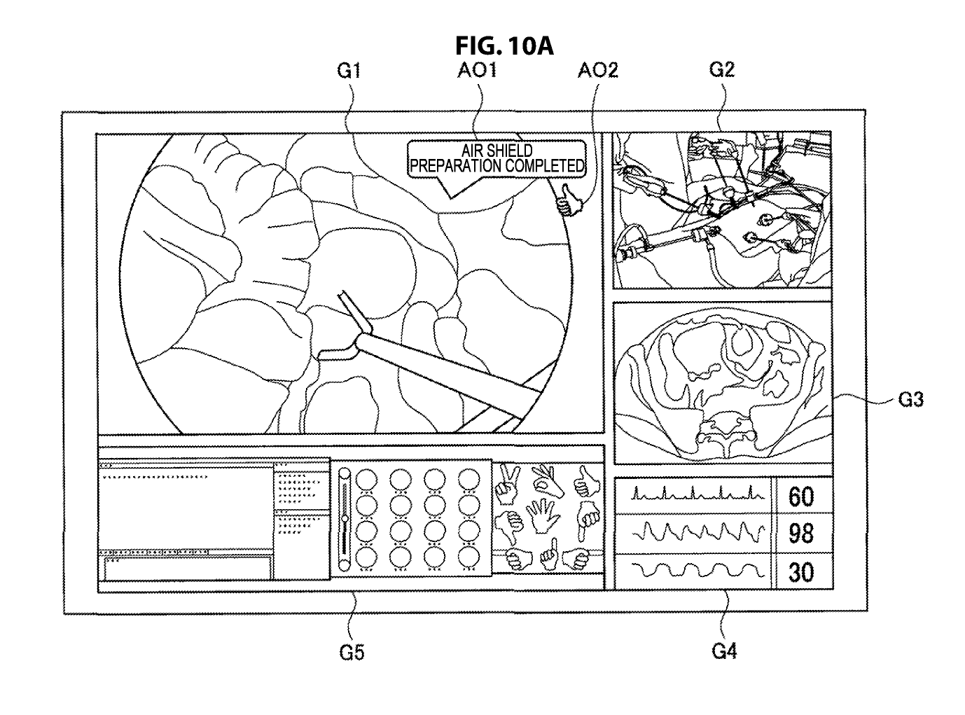

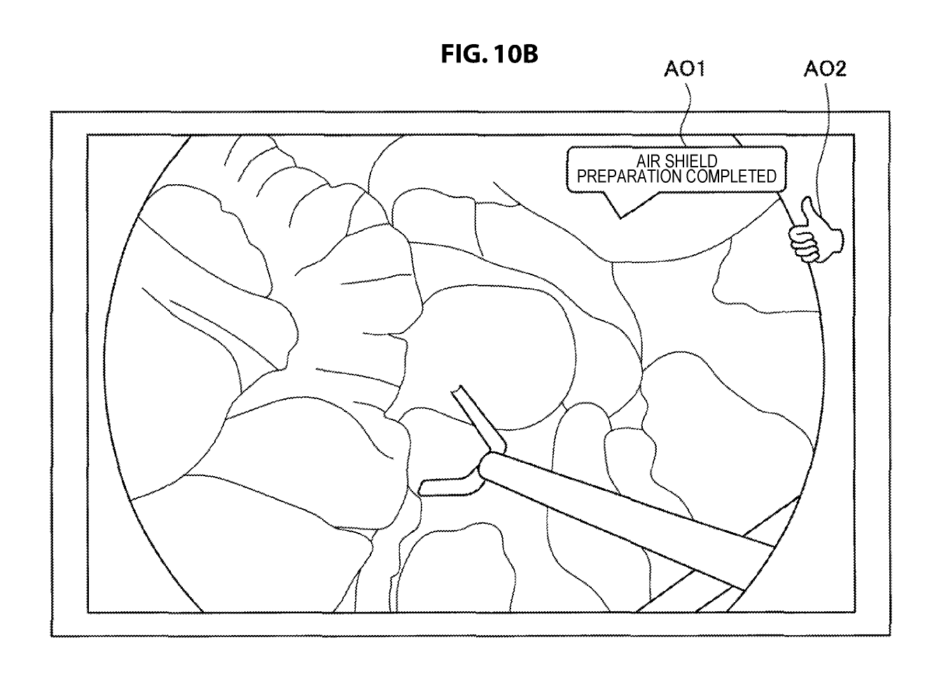

FIGS. 10A and 10B are explanatory diagrams illustrating a sixth display example in the medical image display apparatus 100 according to the embodiment. FIG. 10A illustrates another example of display of images that are displayed on the display screen of the second display unit 104. In addition, FIG. 10B illustrates another example of display of an image that is displayed on the display screen of the first display unit 102 in accordance with a change in display on the display screen of the second display unit 104 illustrated in FIG. 10A.

On the display screen of the second display unit 104 illustrated in FIG. 10A, the images represented by the reference numerals G1 to G5, for example, are displayed. The image G2 illustrates an example of the captured medical image of a space on the side of the display direction of the first display unit 102. In addition, the images G1, G3, and G4 respectively illustrate examples of images related to a medical practice (examples of medical-related images related to the captured medical image). In addition, the image GS illustrates an example of an annotation image for the medical practice (an example of a user interface image). That is, FIG. 10A illustrates an example in which the medical-related image related to the captured medical image of the space on the side of the display direction of the first display unit 102 and the user interface image are displayed with the captured medical image on the display screen of the second display unit 104.

The user who uses the medical image display apparatus 100 can add an annotation object to the image that is displayed on the display screen of the second display unit 104 by performing a user's operation on the image G5 in FIG. 10A in a similar manner to that in a case in which the image illustrated in FIG. 9A, for example is displayed on the display screen of the second display unit 104. FIG. 10A illustrates an example in which an object (AO1 illustrated in FIG. 10A) including a character string and an icon (AO2 illustrated in FIG. 10A) have been added as annotation objects to the image G1 in FIG. 10A, for example.

If the annotation objects AO1 and AO2 are added to the image that is displayed on the display screen of the second display unit 104 as illustrated in FIG. 10A, for example, the annotation objects AO1 and AO2 are added to the image that is displayed on the display screen of the first display unit 102 as illustrated in FIG. 10B in the medical image display apparatus 100. That is, display content of the second display unit 104 is reflected in the display screen of the first display unit 102 according to an operation performed on the annotation image (an example of a user interface image) as illustrated in the image GS in FIG. 10A in the medical image display apparatus 100.

“Making a contact to a practitioner by a circulating nurse or the like in an operation without interrupting a technique by the practitioner when the technique is performed by the practitioner”, for example, can be realized by the display content on the second display unit 104 being reflected in the display screen of the first display unit 102 as illustrated in FIGS. 10A and 10B. That is, in a case in which the medical image display apparatus 100 that has a function with which the display content of the second display unit 104 is reflected in the display screen of the first display unit 102 is used in an operating room (an example of a medical scene), it is possible to improve coordination between the nurse and the practitioner without stopping the operation, for example.

### [3-7] Other Display Examples

The first display example illustrated in [3-1] described above to the sixth display example illustrated in [3-6] described above, for example, are exemplified as display examples in the medical image display apparatus 100 according to the embodiment. In addition, the display examples in the medical image display apparatus 100 according to the embodiment are not limited to the first display example illustrated in [3-1] described above to the sixth display example illustrated in [3-6] described above.

For example, a captured medical image of a space on the side of the display direction of the first display unit 102 may be displayed on the entire display screen of the second display unit 104 in the medical image display apparatus 100 as described above. In addition, in a case in which the captured medical image of the space on the side of the display direction of the first display unit 102 is displayed on the entire display screen of the second display unit 104, the display on the display screen of the second display unit 104 can be changed to another display such as the second display example illustrated in [3-2] described above by a user's operation such as a touch operation performed with an operation body such as a finger on the display screen of the second display unit 104, for example, in the medical image display apparatus 100.

### [4] Examples of Effects That are Achieved by Using Medical Image Display Apparatus According to Embodiment

The following effects are achieved, for example, by using the medical image display apparatus according to the embodiment. Note that it is needless to say that the effects that are achieved by using the medical image display apparatus according to the embodiment are not limited to the following examples.
The person who views the display screen of the second display unit can grasp a space on the back side of the second display unit or the side of the display direction of the first display unit as if the person can see through the side beyond the medical image display apparatus according to the embodiment, by a captured medical image that is displayed on the display screen of the second display unit even in a case in which the size of the medical image display apparatus according to the embodiment increases and a field of vision of the person who views the display screen of the second display unit is physically obstructed by the medical image display apparatus according to the embodiment. Therefore, in a case in which the medical image display apparatus according to the embodiment is used in an operating room (an example of a medical scene), the field of vision of the person who views the display screen of the second display unit is equivalent to a field of vision in an open operation scheme in which no medical image display apparatus is used even if the size of the medical image display apparatus according to the embodiment increases.
A circulating nurse in an operation can address preparation for a next technique while checking the progress of the operation by a medical-related image related to the captured medical image of the space on the back side of the second display unit or the side of the display direction of the first display unit being displayed with the captured medical image on the display screen of the second display unit as illustrated in FIG. 6, for example.
A video image for education that can be used for education of medical professionals such as practitioners is stored in a recording medium by an endoscope image (the image G1 in FIG. 6) and a medical image (the image G5 in FIG. 6) that indicates a character string indicating a result of recognizing sound being displayed on the display screen of the second display unit and an image that indicates display content of the display screen of the second display unit being output to the external recording medium as illustrated in FIG. 6, for example. Here, the moving image for education that is stored in the external storage medium can be used as a material for education with no change added thereto without any particular editing.
In a case in which the second display unit is a touch panel and can display a plurality of images on the second display unit as illustrated in FIG. 6 and the like (in a case in which the second display unit is compatible with so-called multiple windows), the person who uses the medical image display apparatus 100 can arbitrarily change a layout in the display screen of the second display unit and images to be displayed on the display screen of the second display unit by performing a touch operation on the second display unit with a finger or the like.
A circulating nurse or the like in an operation can prepare for the next step in advance while checking an operating image (a captured medical image of a space on the back side of the second display unit or the side of the display direction of the first display unit corresponds thereto) and an image that shows an operative field at the same time by an image that illustrates a flow of an operation and a progress state of a technique in the operation (the image G5 illustrated in FIG. 8; an example of a medical-related image) and an image that illustrates an operative field (the image G1 illustrated in FIG. 8; an example of a medical-related image) and a captured medical image of the space on the back side of the second display unit or the side of the display direction of the first display unit being displayed together on the display screen of the second display unit as illustrated in FIG. 8, for example. That is, operation management by a technique progress table is realized by the image ad illustrated in FIG. 8, for example, being displayed on the display screen of the second display unit.
It is possible to improve communication between practitioners and the entire operation team, for example, by coordinated display being performed between the display screen of the second display unit 104 and the display screen of the first display unit 102 as illustrated in FIGS. 9A and 9B or FIGS. 10A and 10BA, for example.

### (Program According to Eembodiment)

It is possible to improve convenience by a program (a program capable of executing the processing related to the display control method according to the embodiment, for example) for causing a computer system to function as the medical image display apparatus according to the embodiment (or the display control apparatus capable of controlling the medical image display apparatus according to the embodiment) being executed by a processor or the like in the computer system. Here, a single computer or a plurality of computers are exemplified as the computer system according to the embodiment. A series of processing related to the display control method according to the embodiment is performed by the computer system according to the embodiment.

In addition, it is possible to achieve effects, which can be achieved by display realized by the processing related to the aforementioned display control method according to the embodiment, by the program for causing the computer system to function as the medical image display apparatus according to the embodiment (or the display control apparatus capable of controlling the medical image display apparatus according to the embodiment) being executed by the processor or the like in the computer system.

It should be understood by those skilled in the art that various modifications, combinations, sub-combinations and alterations may occur depending on design requirements and other factors insofar as they are within the scope of the appended claims or the equivalents thereof.

For example, although the provision of the program (computer program) for causing the computer system to function as the medical image display apparatus according to the embodiment (or the display control apparatus capable of controlling the medical image display apparatus according to the embodiment) has been described above, the embodiment can further provide a recording medium that is made to store the aforementioned program together.

The aforementioned configurations illustrate examples of the embodiment, and it is a matter of course that the configurations belong to the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.
(1) A medical image display apparatus including:

a first display unit; and

a second display unit that has a different display direction from a display direction of the first display unit,

in which a captured medical image of a space on a back side of the second display unit is displayed on at least a part of a display screen of the second display unit.
(2) The medical image display apparatus according to (1),

in which the captured medical image is a captured medical image of a space on a side of the display direction of the first display unit.
(3) The medical image display apparatus according to (1), in which one or two or more of a medical-related image related to the captured medical image, a medical image that indicates a character string indicating a result of recognizing sound collected by a microphone, and a user interface image are displayed with the captured medical image on the display screen of the second display unit.
(4) The medical image display apparatus according to (3),

in which the captured medical image is a captured image of the space at a location where a medical practice is performed, and

the medical-related image is an image related to the medical practice.
(5) The medical image display apparatus according to (4), in which one of or both an image related to a patient who receives the medical practice and an image that indicates a flow of the medical practice are included in the image related to the medical practice.
(6) The medical image display apparatus according to any one of (3) to (5), in which an annotation image for a medical practice is included in the user interface image.
(7) The medical image display apparatus according to any one of (3) to (6), in which, in a case in which an operation is performed on the user interface image, display of the second display unit changes according to the operation performed on the user interface image.
(8) The medical image display apparatus according to (7), in which content of the display of the second display unit is reflected on a display screen of the first display unit according to the operation performed on the user interface image.
(9) The medical image display apparatus according to any one of (3) to (8), including:

the microphone,

in which the character string is a character string that indicates a result of recognizing sound collected by the microphone provided in the medical image display apparatus.
(10) The medical image display apparatus according to any one of (3) to (9), in which a layout of images to be displayed on the display screen of the second display unit, a number of the images to be displayed on the display screen of the second display unit, and content of the images to be displayed on the display screen of the second display unit are each changed on a basis of a user's operation.
(11) The medical image display apparatus according to any one of (1) to (10), including:

an imaging device that captures an image of the space on the back side of the second display unit,

in which the captured medical image is an image captured by the imaging device provided in the medical image display apparatus.
(12) The medical image display apparatus according to any one of (1) to (11), further including:

a control unit that controls display on respective display screens of the first display unit and the second display unit.
(13) The medical image display apparatus according to any one of (1) to (12), including:

an output terminal that outputs an image indicating display content that is displayed on the display screen of the second display unit.
(14) The medical image display apparatus according to any one of (1) to (13), in which a size of a display screen of the first display unit and a size of the display screen of the second display unit are the same.
(15) The medical image display apparatus according to any one of (1) to (13), in which a size of a display screen of the first display unit and a size of the display screen of the second display unit are different.
(16) The medical image display apparatus according to (15), in which the size of the display screen of the second display unit is smaller than the size of the display screen of the first display unit.
(17) The medical image display apparatus according to any one of (1) to (16), in which resolution of a display screen of the first display unit and resolution of the display screen of the second display unit are the same.
(18) The medical image display apparatus according to any one of (1) to (16), in which resolution of a display screen of the first display unit and resolution of the display screen of the second display unit are different.
(19) The medical image display apparatus according to (18), in which the resolution of the display screen of the second display unit is lower than the resolution of the display screen of the first display unit.
(20) The medical image display apparatus according to any one of (1) to (19), in which the second display unit is a touch panel.
(21) A display control method that is performed in a medical image display apparatus including a first display unit and a second display unit that has a different display direction from a display direction of the first display unit, the method being executed by a processor, the method including:

controlling display such that a captured medical image of a space on a back side of the second display unit is displayed on at least a part of a display screen of the second display unit.

What is claimed is:

1. A medical image display apparatus comprising:
a first display unit; and
a second display unit that has a different display direction from a display direction of the first display unit,
wherein a captured medical image of a space on a back side of the second display unit is displayed on at least a part of a display screen of the second display unit.

2. The medical image display apparatus according to claim 1,
wherein the captured medical image is a captured medical image of a space on a side of the display direction of the first display unit.

3. The medical image display apparatus according to claim 1, wherein one or two or more of a medical-related image related to the captured medical image, a medical image that indicates a character string indicating a result of recognizing sound collected by a microphone, and a user interface image are displayed with the captured medical image on the display screen of the second display unit.

4. The medical image display apparatus according to claim 3,
wherein the captured medical image is a captured image of the space at a location where a medical practice is performed, and
the medical-related image is an image related to the medical practice.

5. The medical image display apparatus according to claim 4, wherein one of or both an image related to a patient who receives the medical practice and an image that indicates a flow of the medical practice are included in the image related to the medical practice.

6. The medical image display apparatus according to claim 3, wherein an annotation image for a medical practice is included in the user interface image.

7. The medical image display apparatus according to claim 3, wherein, in a case in which an operation is performed on the user interface image, display of the second display unit changes according to the operation performed on the user interface image.

8. The medical image display apparatus according to claim 7, wherein content of the display of the second display unit is reflected on a display screen of the first display unit according to the operation performed on the user interface image.

9. The medical image display apparatus according to claim 3, comprising:
the microphone,
wherein the character string is a character string that indicates a result of recognizing sound collected by the microphone provided in the medical image display apparatus.

10. The medical image display apparatus according to claim 3, wherein a layout of images to be displayed on the display screen of the second display unit, a number of the images to be displayed on the display screen of the second display unit, and content of the images to be displayed on the display screen of the second display unit are each changed on a basis of a user's operation.

11. The medical image display apparatus according to claim 1, comprising:
an imaging device that captures an image of the space on the back side of the second display unit,
wherein the captured medical image is an image captured by the imaging device provided in the medical image display apparatus.

12. The medical image display apparatus according to claim 1, further comprising:
a control unit that controls display on respective display screens of the first display unit and the second display unit.

13. The medical image display apparatus according to claim 1, comprising:
an output terminal that outputs an image indicating display content that is displayed on the display screen of the second display unit.

14. The medical image display apparatus according to claim 1, wherein a size of a display screen of the first display unit and a size of the display screen of the second display unit are the same.

15. The medical image display apparatus according to claim 1, wherein a size of a display screen of the first display unit and a size of the display screen of the second display unit are different.

16. The medical image display apparatus according to claim 15, wherein the size of the display screen of the second display unit is smaller than the size of the display screen of the first display unit.

17. The medical image display apparatus according to claim 1, wherein resolution of a display screen of the first display unit and resolution of the display screen of the second display unit are the same.

18. The medical image display apparatus according to claim 1, wherein resolution of a display screen of the first display unit and resolution of the display screen of the second display unit are different.

19. The medical image display apparatus according to claim 18, wherein the resolution of the display screen of the second display unit is lower than the resolution of the display screen of the first display unit.

20. The medical image display apparatus according to claim 1, wherein the second display unit is a touch panel.

21. A display control method that is performed in a medical image display apparatus including a first display unit and a second display unit that has a different display direction from a display direction of the first display unit, the method being executed by a processor, the method comprising:
controlling display such that a captured medical image of a space on a back side of the second display unit is displayed on at least a part of a display screen of the second display unit.
